(19) United States
(12) Patent Application Publication
(10) Pub. No.: US 2002/0178040 A1
(43) Pub. Date: Nov. 28, 2002

(54) Group management service support method for buildings, support device, support system, and computer program storage medium

(76) Inventors: Yoshiaki Usami, Hitachi (JP); Masanori Miyoshi, Mito (JP); Hiroshi Shojima, Hitachiota (JP)

Correspondence Address: DICKSTEIN SHAPIRO MORIN & OSHINSKY LLP, 2101 L STREET NW, WASHINGTON, DC, 20037-1526, US

(21) Appl. No.: 10/196,559

(22) Filed: Jul. 17, 2002

Related U.S. Application Data
(62) Division of application No. 10/004,799, filed on Dec. 7, 2001.

(30) Foreign Application Priority Data
Dec. 8, 2000 (JP) 2000-379754
Jul. 3, 2001 (JP) 2001-202480

(51) Int. Cl. G06F 17/60

(52) U.S. Cl. 705/7

(57) ABSTRACT

It is difficult for the facility owner to decide a most suitable combination from many maintenance companies by himself. Further, it is difficult to evaluate maintenance services only by price. In order to solve the above problem, when the facility manager is entrusted with management of the facilities from the facility owner, he analyzes the service characteristics of the facility maintenance companies, prepares combinations of maintenance companies having a same service trend, and indicates maintenance information of the facilities and an evaluated value on the basis of opinions of users and the facility companies select maintenance services of facility management from the combinations by referring to the evaluated value. In this case, the service evaluated value on the basis of the maintenance information of the facilities and users' opinions is also indicated at the same time.

### BACKGROUND OF THE INVENTION

The present invention relates to a group management service support method for buildings and a support device and more particularly to a group management service support method for buildings and a support device suited to integratedly manage facilities and structures of a plurality of buildings such as offices and apartments.

As a method for handling management information of a plurality of buildings, as the facility management system for buildings described in Japanese Application Patent Laid-Open Publication No. Hei 05-244661, a method for dividing buildings into a plurality of sections, connecting the section blocks to the center by a network, thereby efficiently manage them is known.

On the other hand, in the market of financial goods such as stock and credit, a business is executed that a stock company sells a plurality of financial goods to investors by setting a combination as a fund like investment trust, and an investment company invests according to a preset policy, and a ranking company publishes performance of each financial goods and fund. As a systematic support for it, for example, in the overall portfolio planning system described in Japanese Application Patent Laid-Open Publication No. Hei 11-110447, a most suitable combination of financial goods can be planned by reflecting a life plan and risk acceptance level of each investor.

### SUMMARY OF THE INVENTION

As a problem of the prior art, with respect to building facilities, maintenance companies are different for each device kind and there are many maintenance companies. Therefore, it is a difficult operation for a building owner to select a most suitable maintenance company from many candidates. Further, although there is a facility manager for being entrusted with the operation management of whole facilities from a facility owner and selecting and managing a necessary maintenance company, from the viewpoint of the facility owner, a problem arises that the standard for selection of the maintenance company is not clear.

To manage facility maintenance services, a financial method such as the overall portfolio planning system mentioned above cannot be used as it is. In the case of financial goods, each goods can be evaluated only by the price of the goods, while the evaluation of maintenance services cannot be judged only by the price and the evaluation is difficult. To evaluate maintenance services, in addition to the price, it is important to confirm the condition of the maintained facilities themselves or confirm the opinion of a user of the facilities.

Further, as a second problem of the prior art, it may be cited that there is no service support system for minimizing the life cycle cost of buildings. Each building is used over a long period of several tens years, so that the life cycle cost such as maintenance and repair costs are enormous and reduction thereof is strongly required. Particularly, in large-scale repairs such as repairs of outer walls, a great deal of expense is required, so that it is necessary to improve the operation of services for repairs and reduce the cost. In the conventional buildings management system, the information management for buildings is unified, while optimization of the operation of management services is not taken into account.

Therefore, an object of the present invention is to provide a group management service support method for buildings and a support device for reflecting management results of facilities subjected to maintenance and opinions of users, thereby easily selecting a combination of most suitable maintenance services.

Another object of the present invention is to provide a group management service support method for buildings and a support device for using a scale merit in the case of managing buildings as a group and minimizing the life cycle cost.

The first object of the present invention is a group management service support method for buildings for managing facilities composed of a plurality of maintenance subjects using a computer system by a facility manager entrusted with operations of a plurality of maintenance companies for executing maintenance for each of the concerned maintenance subjects for the facilities from a facility owner having the concerned facilities, and the computer system is connected to the facility owner terminal and the facility manager terminal via a network, and the facility manager terminal extracts maintenance service characteristics of each of the maintenance companies, decides combinations of maintenance companies having the same concerned service characteristics of all the maintenance subjects as maintenance plans, decides the evaluation for the operation of the concerned facilities as facility operation evaluation on the basis of maintenance information including a fault time or fault contents output from the concerned facilities, and indicates the plurality of concerned maintenance plans and the concerned facility operation evaluation on the facility owner terminal, and the facility owner terminal selects a maintenance plan entrusted with management from the plurality of concerned maintenance plans and notifies the facility manager terminal of it, thus the object is accomplished.

According to the present invention, a combination of most suitable maintenance companies according to the object is indicated, so that the facility owner only may select a combination of maintenance companies according to the management intention and there is an effect produced that suitable companies can be selected easily. Further, evaluation of maintenance services is executed continuously, so that the facilities are operated suitably according to the management intention.

Further, the second object of the present invention is a building group management service support system having a computer, and the computer has a conversion means for converting the first condition data of a predetermined number of parameters for indicating the input operation condition of building facilities and service characteristics to the second condition data that the number of concerned parameters is reduced by holding the characteristics of the concerned operation condition represented by the concerned data and a calculation means for outputting, when an indication value is input by a parameter of the second condition data, information for identifying a facility having the second condition data closest to the indicated value, thus the object is accomplished by the building group management service support system.

According to the present invention, group management services of buildings for using a scale merit in the case of managing buildings as a group and minimizing the life cycle cost are provided.

### BRIEF DESCRIPTION OF THE DRAWINGS

FIG. 1 is a drawing for illustrating the whole constitution of a building group management service support system of an embodiment of the present invention,

FIG. 2 is a drawing for illustrating the outline of the system,

FIG. 3 is a drawing for illustrating the outline of the procedure,

FIG. 4 is a drawing for illustrating the constitution of the system,

FIG. 5 is a sequence diagram of the system,

FIG. 6 is a sequence diagram of the system,

FIG. 7 is a sequence diagram of the system,

FIG. 8 is a drawing for illustrating a data file,

FIG. 9 is a drawing for illustrating an example of a terminal screen,

FIG. 10 is a drawing for illustrating input data,

FIG. 11 is a drawing for illustrating input data,

FIG. 12 is a drawing for illustrating input data,

FIG. 13 is a drawing for illustrating the data analytical method,

FIG. 14 is a drawing for illustrating an example of the terminal screen,

FIG. 15 is a drawing for illustrating input data,

FIG. 16 is a drawing for illustrating input data,

FIG. 17 is a drawing for illustrating input data,

FIG. 18 is a drawing for illustrating an example of the terminal screen,

FIG. 19 is a drawing for illustrating a calculation model of the system,

FIG. 20 is a drawing for illustrating a calculation model of the system,

FIG. 21 is a drawing for illustrating an example of the terminal screen,

FIG. 22 is a flow chart of the system, and

FIG. 23 is a drawing for illustrating an example of the terminal screen.

### DETAILED DESCRIPTION OF THE PREFERRED EMBODIMENT

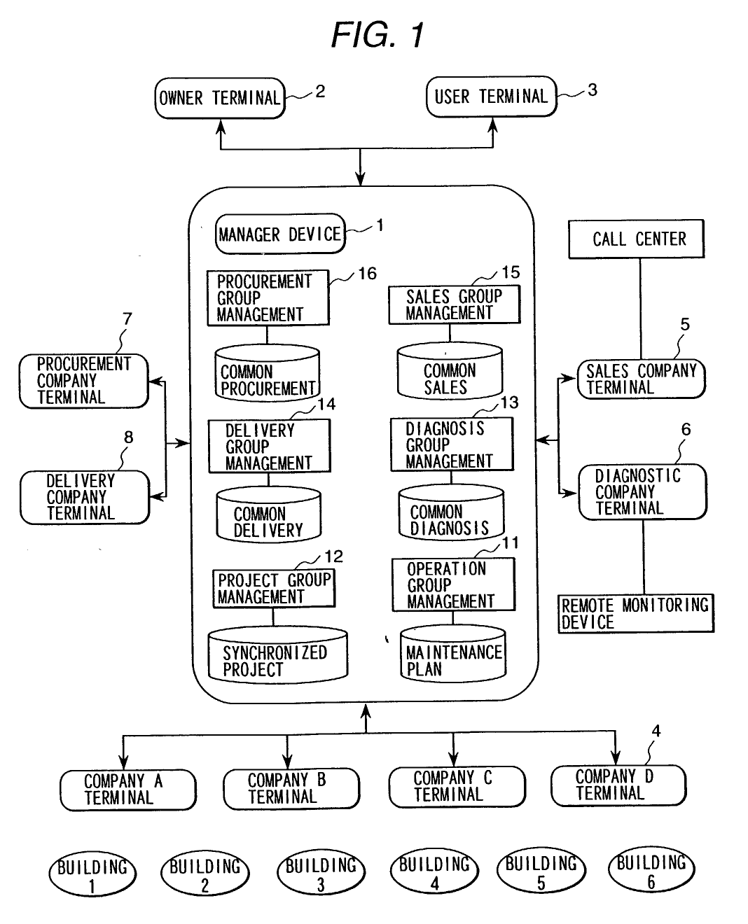

An embodiment of the present invention will be explained in detail hereunder with reference to the accompanying drawings. FIG. 1 is a drawing for illustrating the whole constitution of a building group management service support system using a computer system of the present invention.

Numeral 1 indicates a building manager device terminal using a computer and is composed of a sub-system such as operation group management, step group management, diagnosis group management, distribution group management, business group management, and supply group management. Numeral 2 indicates a terminal of a building owner and 3 indicates a terminal of a building user or resident. Numeral 4 indicates terminals of companies A, B, C, and D, and in the case of maintenance, maintenance companies of guide, cleaning, air conditioning, and an elevator are equivalent to them, and in the case of repairs, work companies such as steeplejacking, plastering, painting, electricity, city water, and gas are equivalent to them. Furthermore, numeral 5 indicates a terminal of a person in charge of business, 6 a terminal of a person in charge of diagnosis, 7 a terminal of a person in charge of supply, and 8 a terminal of a person in charge of distribution. Each of the terminals is also composed of a computer and the manager device terminal 1 and each terminal are connected to each other via a communication network.

This system supports management services in a case of handling the building group, for example, a building 1 to a building 6. Numeral 11 indicates a sub-system of operation group management, which evaluates service characteristics of the companies 4 of maintenance and repair and can select a most suitable combination of companies from indicated maintenance plans by a building owner according to his management intention. Numeral 12 indicates a step group management sub-system, which synchronizes the building repair time, which is originally different for each building, at most suitable timing and outputs as a synchronization step.

Numeral 13 indicates a sub-system of diagnosis group management, which manages a remote control monitoring device for facilities such as an elevator and an air conditioner and structure diagnosis by a building specialist. Also in this case, the diagnosis time for each building is shared and the diagnosis information thereof is stored in the common diagnosis data base. Numeral 14 indicates a sub-system of distribution group management, which decides a combination of companies for giving services by the operation group management, so that in the same maintenance plan, the company is the same for any building and the distribution operation can be shared. Materials to be used for operations of maintenance and repair are distributed, for example, by a common car instead of distributing to each building for each company. Information for managing such distribution is stored in the common distribution data base.

Numeral 15 indicates a sub-system of business group management, which intends to unite the business windows using that the companies are common. Inquiries from building owners and users are sent to the call center in a batch via various channels such as a telephone and mail and the information is registered in the common business data base. Numeral 16 indicates a sub-system of supply group management, which operates also under the same specification for the same maintenance plan, so that materials to be supplied are common. Therefore, materials for all the buildings are ordered together by the sub-system. The information for supply is stored in the common supply data base.

Hereunder, the sub-system of operation group management and the sub-system of step group management will be explained in detail.

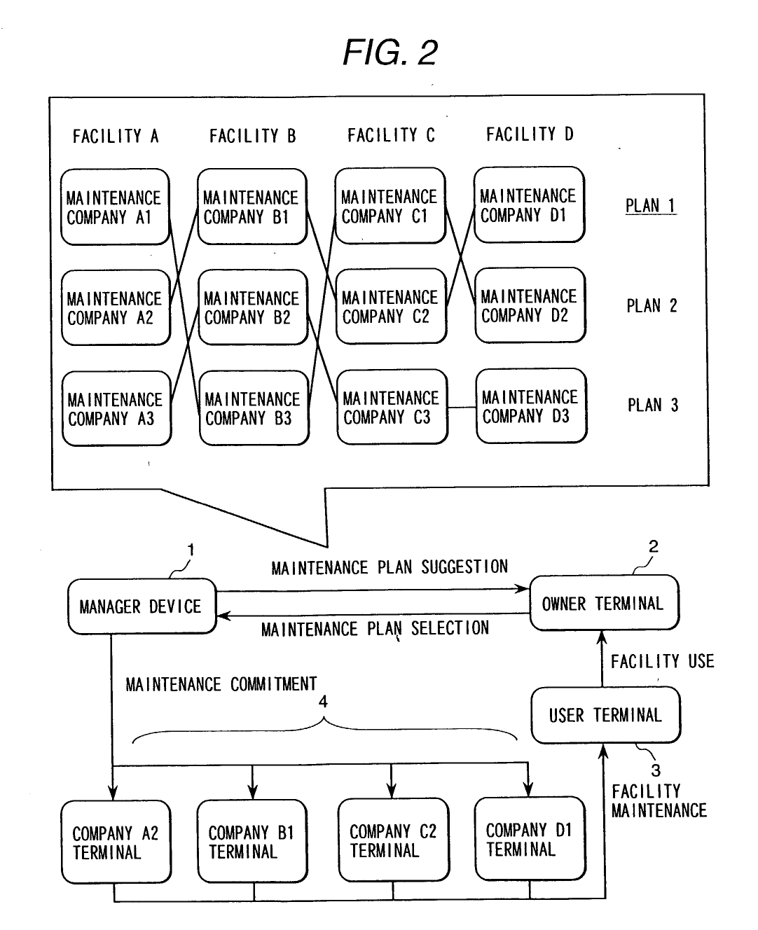

FIG. 2 is a drawing for illustrating the outline of the sub-system of operation group management of this embodiment of the present invention. The present invention is composed of the manager device 1 of a facility manager for executing operation management of the facilities, the owner terminal 2 of a facility owner having the facilities, the user terminal 3 of a facility user using the facilities, and the company terminals 4 of maintenance companies for being entrusted with maintenance from the facility manager and maintaining the facilities. The process of the present invention is to indicate maintenance plans by the facility manager and select a maintenance plan by the facility owner. In this case, the maintenance plan indicates a combination of companies of maintenance or repair. For example, in building facility maintenance, guide corresponds to the facility A, cleaning to the facility B, air conditioning to the facility C, and an elevator to the facility D.

However, business such as guide or cleaning may not be actually limited only to maintenance of a specific facility. And, it is assumed that with respect to the facility A, there exist maintenance companies A1, A2, and A3, and in the same way, with respect to the facility B, there exist maintenance companies B1, B2, and B3, and with respect to the facility C, there exist maintenance companies C1, C2, and C3, and with respect to the facility D, there exist maintenance companies D1, D2, and D3. Here, the service characteristics of the respective maintenance companies are evaluated and in this example, they are divided into three maintenance plans.

In the drawing, for example, the plan 1 is a cost priority type maintenance plan combining low-cost maintenance companies of A2, B1, C2, and D1 in serious consideration of cost, and the plan 2 is a quality priority type maintenance plan combining maintenance companies with an established reputation for the quality of A1, B3, C1, and D2 in serious consideration of quality, and the plan 3 is a balance type maintenance plan combining maintenance companies of A3, B2, C3, and D3 in consideration of the balance between cost and quality. In this example, the facility owner selects the maintenance plan 1 and as a result, the maintenance company of the combination is entrusted with maintenance.

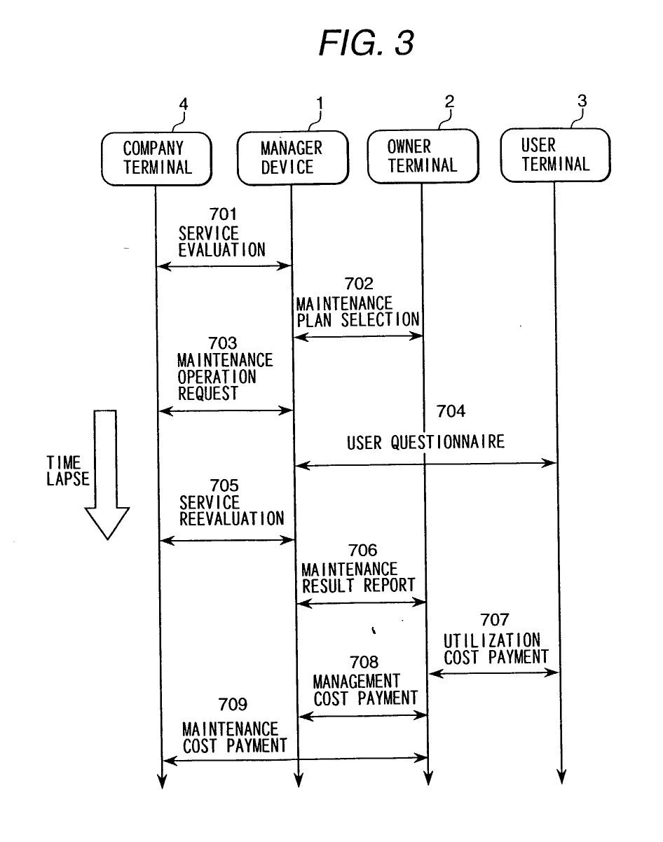

FIG. 3 is a drawing for illustrating the outline of the procedure of the system of the present invention. The drawing shows the procedure between the persons concerned with time and the time elapses downward in the drawing. Firstly, the manager device executes the service evaluation process (701) between the device and the terminal company. This is a procedure for evaluating the past service contents of the company terminal. Next, between the manager device and the owner terminal, a proposal of maintenance plans and the maintenance plan selection process (702) are performed on the basis of the evaluation result 701. The manager device indicates all the maintenance plans prepared from various viewpoints such as cost, term of work, quality, and service at the owner terminal and the owner terminal selects the maintenance plan agreeing with the desired conditions among them. And according to the selected result 702, between the manager device and the company terminal, the maintenance request process (703) is executed and an actual maintenance operation is started.

The user questionnaire process (704) performed between the manager device and the user terminal is performed so as to evaluate the contents of the maintenance service executed. With respect to the service evaluation, fault information from the facilities is additionally taken into account and on the basis of the result, the service reevaluation process (705) is executed between the company terminal and the manager device. Thereafter, on the basis of the result of 705, the maintenance result report process (706) is executed between the manager device and the owner terminal. And, the use expense payment process (707) is performed between the user terminal and the owner terminal, the management cost payment process (708) between the owner terminal and the manager device, and the maintenance cost payment process (709) between the owner terminal and the company terminal and a series of business processes ends.

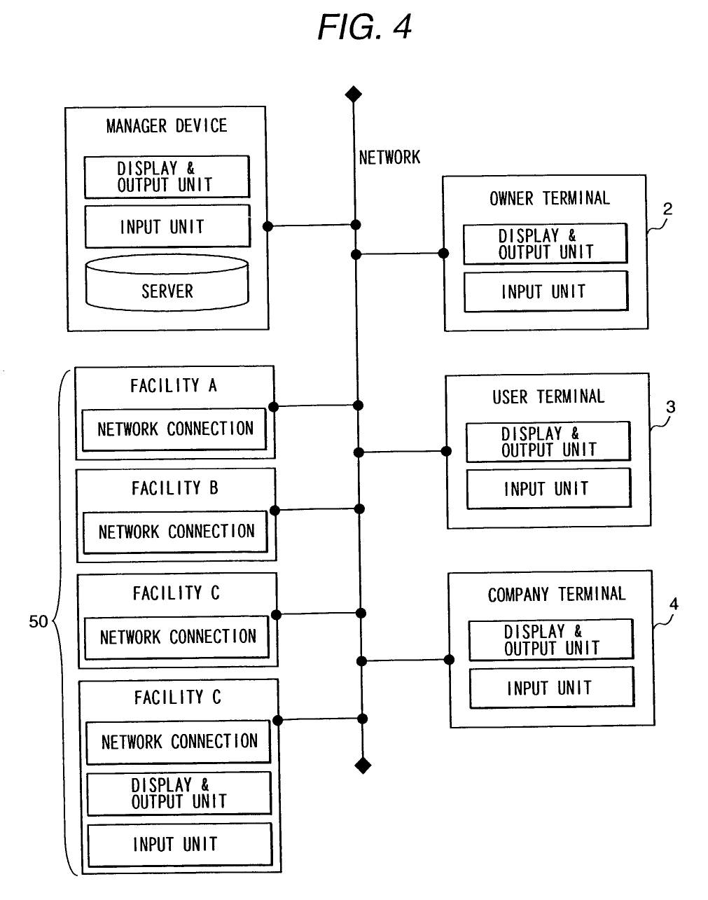

FIG. 4 is a drawing for illustrating the constitution of the system of the present invention. The manager device (10) is generally a personal computer, which is composed of a display and output unit such as a display, an input unit such as a keyboard and a mouse, and a server capable of being accessed from other terminals via a network. The owner terminal (2), the user terminal (3), and the company terminal (4) are also generally a personal computer and composed of a display and output unit and an input unit in the same way. The facilities (50) are facilities to be maintained, which internally have a network connection and may have a function for sending maintenance information such as self diagnosis results of the facilities to the network. Some facilities may have a display and output unit such as a crystal liquid display and an input unit such as a touch panel. According to the present invention, all kinds of management information are recorded in the server 10 and the process is performed by referring to the information.

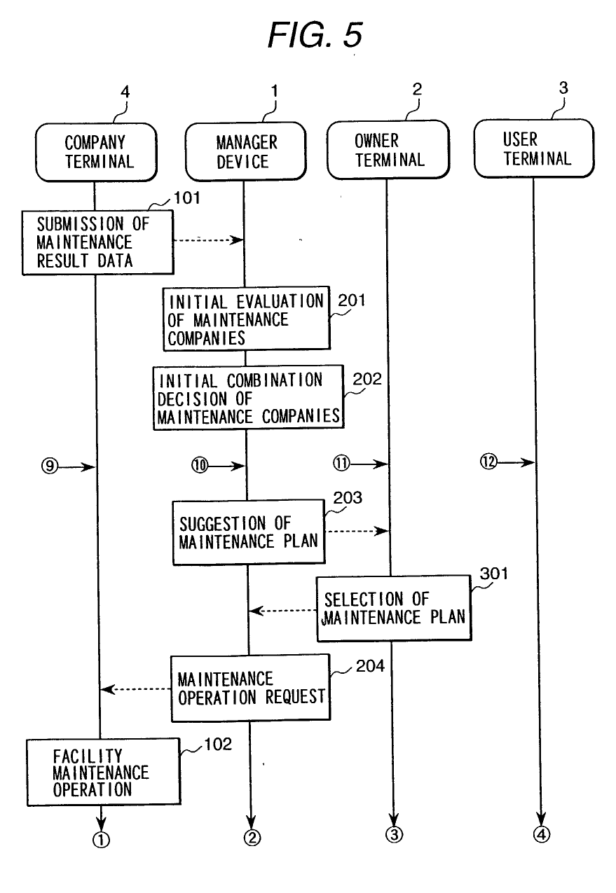

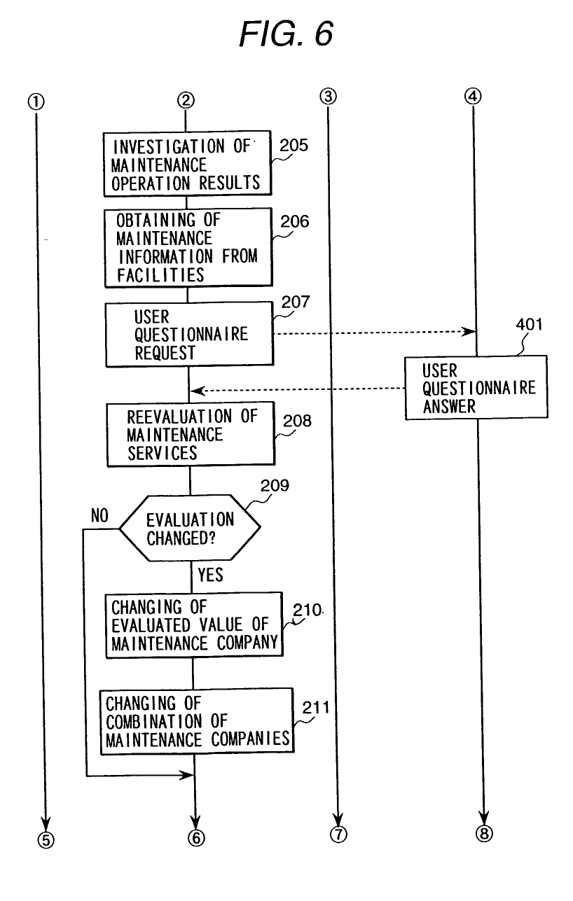

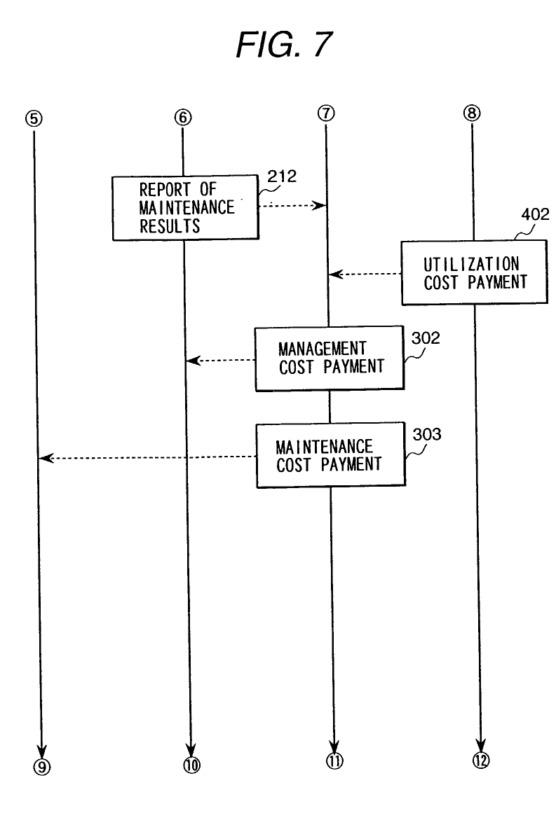

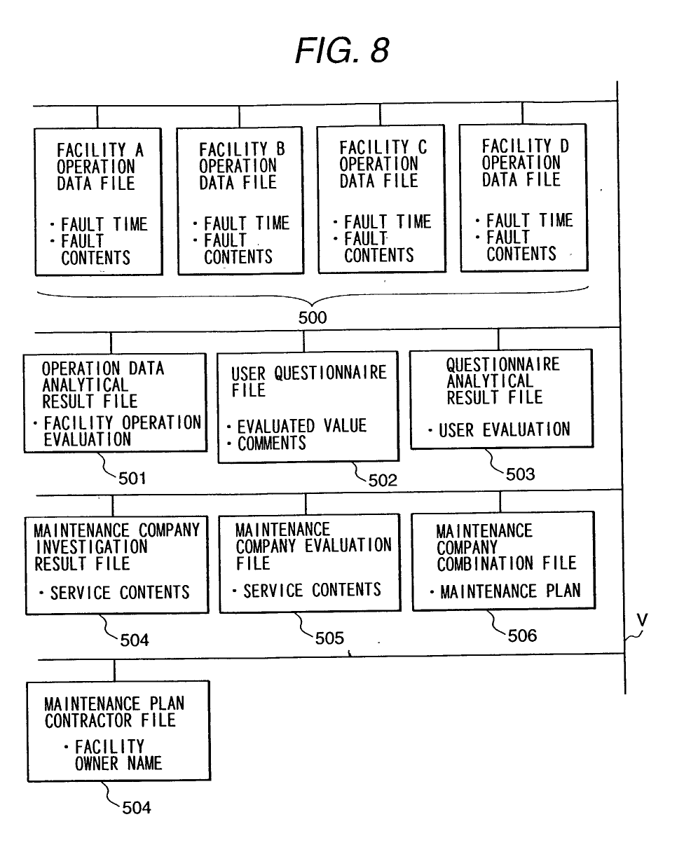

FIGS. 5, 6, and 7 are sequence drawings of the operation group management subsystem of the present invention. Further, FIG. 8 is an illustration for the data files in the server of the manager device.

Next, the process will be explained in detail using the illustration of this sequence and data file. In the sequence 101, the company terminal submits actual maintenance data to the manager device. This data indicates the actual results of service contents executed by the concerned company in the past and the information is recorded as an item of service contents of the investigation result file (504) of the maintenance company by the system.

The sequence 201 is a sequence for the manager device to execute initial evaluation for the maintenance companies and the manager device ranks services of the maintenance companies by referring to the record 504. For example, the services are divided into several ranks and the classified result is recorded as an item of service evaluation of the evaluation file (505) of the maintenance companies by the system.

In the sequence 202, the manager device decides an initial combination of the maintenance companies. Namely, from the evaluation result of 201, the manager device obtains the service characteristics of each of the maintenance companies, considers several maintenance plans for each characteristic, and decides a most suitable initial combination of maintenance companies for construction of the maintenance plans. This decision result is recorded as an item of maintenance plan of the combination file (506) of the maintenance companies by the system. As an example of the plans, the manager device prepares a plan in serious consideration of cost, a plan in serious consideration of performance, and a plan average to all.

In the sequence 203, the manager device indicates a maintenance plan to the owner terminal. Here, the maintenance plan of 506 is indicated by the system.

In the sequence 301, the owner terminal selects a maintenance plan. The selection of maintenance plan can be decided by the facility owner according to each facility management intention. When the plan is selected, the selected facility owner name is recorded in the maintenance plan contractor file (507) by the system.

In the sequence 204, the manager device designates the maintenance company on the basis of the selected maintenance plan and requests the maintenance operation to the concerned maintenance company.

In the sequence 102, the designated company terminal instructs the maintenance operation for facilities.

In the sequence 205, the manager device investigates the maintenance operation results executed in the sequence 102. The investigation results are recorded in the investigation result file 504 of the maintenance company as an addition to the actual maintenance data recorded by the sequence 101.

In the sequence 206, the manager device obtains maintenance information from the facilities. As mentioned above, the facilities 50 can send maintenance information, so that the data is automatically recorded in the server of 10. The data is similar to the operation data file (500) of each facility and stores maintenance information as an item of fault time or fault contents.

In the sequence 207, the manager device requests a user questionnaire to the user terminal. The reason is that the degree of satisfaction when he uses the facilities is measured by the questionnaire.

In the sequence 401, the user terminal answers the manager terminal about the user questionnaire. The answer result is recorded as an item of the evaluation value and comment of the user questionnaire file (502) by the system. In this case, the evaluation value is pointed values regarding the questionnaire such as “fully thinking so”: 5 points, “slightly thinking so”: 4 points, “general”: 3 points, “not thinking so much”: 2 points, and “not thinking so at all”: 1 point. Further, the comment is text data described in a free sentence.

In the sequence 208, the manager device reevaluates maintenance services. In this case, from the contents of the facility operation data file 500, the facility manager analyzes and evaluates the facility operation condition and the ranked result is recorded in the item of facility operation evaluation of the operation data analytical result file (501) by the system. Further, the facility manager also analyzes the user questionnaire and in the same way, the ranked result is recorded as an item of user evaluation of the questionnaire analytical result file (503) by the system.

The sequence 209 indicates that only when the evaluation of the maintenance company is changed by the sequence 208, the process goes to the sequence 210. When the evaluation is not changed, the process goes to the sequence 212.

In the sequence 210, the manager device changes the evaluation value of the maintenance company. For the changed evaluation value, the contents of the evaluation file 505 of the maintenance company are rewritten by the system. In the sequence 211, the manager device changes the combination of maintenance companies in the maintenance plan. For the changed combination, the contents of the maintenance company combination file 506 are rewritten by the system. In the sequence 212, the manager device reports the executed maintenance operation and evaluation thereof to the owner terminal.

In the sequence 402, the user terminal performs the payment process of facility use expense for the owner terminal.

In the sequence 302, the owner terminal performs the payment process of facility management cost for the manager device. In the sequence 303, the owner terminal performs the payment process of facility maintenance cost for the company terminal.

In this way, one cycle of facility management ends and as a next cycle, the process goes to the sequence 203 again.

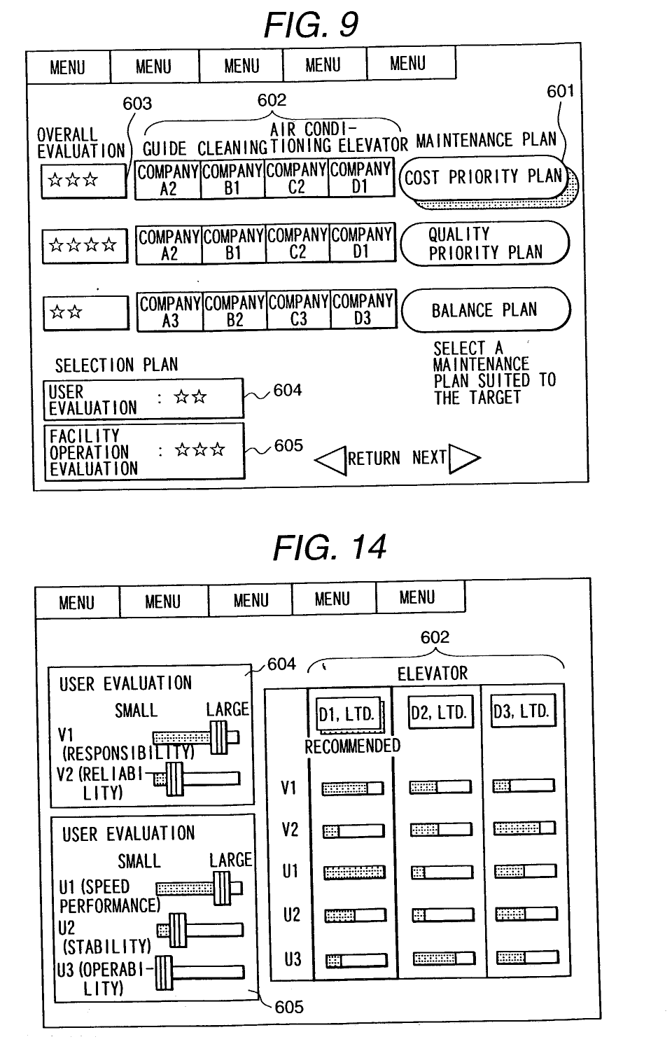

FIG. 9 is an example of I/O screen and shows a screen of the owner terminal. This screen shows the condition in the sequence 301. The maintenance service combination display unit (602) displays the combination of maintenance companies from the contents of the maintenance company combination file 506. The overall evaluation display unit (603) decides and displays the overall evaluation of maintenance plans from the contents of 506 and the maintenance company evaluation file 505. In the maintenance plan selection unit (601), the facility owner selects a plan and in this case, the cost priority plan is selected. Furthermore, the user evaluation display unit (604), as additional information concerning the plan, displays evaluation results by the user from the contents of the questionnaire analytical result file 503. Further, the facility operation evaluation display unit (605) displays the facility operation results as evaluated ones from the contents of the operation data analytical result file 501.

In the aforementioned embodiment, the facility manager evaluates the services of the maintenance company, thereby requests the operation. However, an evaluation company who is an independent third person can specially execute evaluation of maintenance services. According to this embodiment, a person in charge of operation request and a person in charge of evaluation are separated from each other, so that incorrect evaluation can be prevented and the transparency of dealing with facility management can be improved more.

In the aforementioned embodiment, each maintenance company has a single service characteristic, though he can provide a plurality of different service characteristics. According to this embodiment, the same maintenance company can provide services according to needs of the facility owner and facility user, so that an effect such that the selection width of the facility owner is extended or chances of participation of maintenance companies are increased is produced.

In the aforementioned embodiment, each maintenance company maintains only a single facility, though when the skill of each maintenance operator is diversified, the same maintenance company can maintain a plurality of facilities. According to this embodiment, a plurality of facilities can be maintained at the same time, so that an effect such that the maintenance cost can be reduced is produced.

Unlike the aforementioned embodiment, service characteristics of a company of maintenance or repair can be evaluated using the method of statistics. In this embodiment, the main component analytical method of statistics is applied to facility operation results and user questionnaire results, thus a method for providing a means for evaluation and selection of services will be explained.

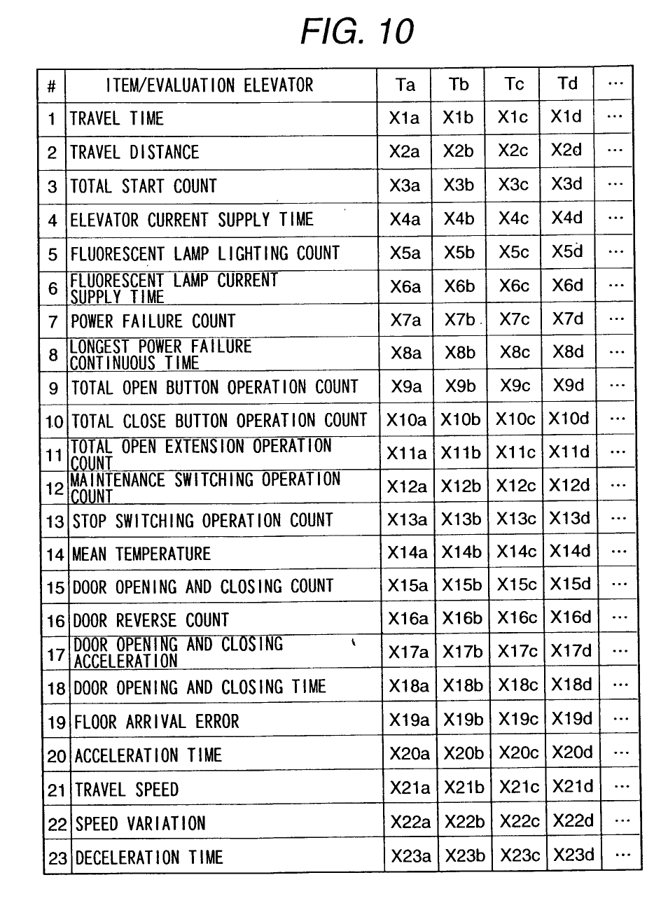

FIG. 10 shows facility operation data, which is an example of information managed by an elevator remote monitoring device. In this example, Ta and Tb indicate individual managed elevators, and 26 items including the travel time and travel distance are measured for each of them, and the values are managed. For example, X1a indicates the travel time of the elevator Ta and X2b indicates the travel distance of the elevator Tb. These kinds of information are recorded as partial information of the operation data analytical result file 501 in the server of the manager device from the remote monitoring device.

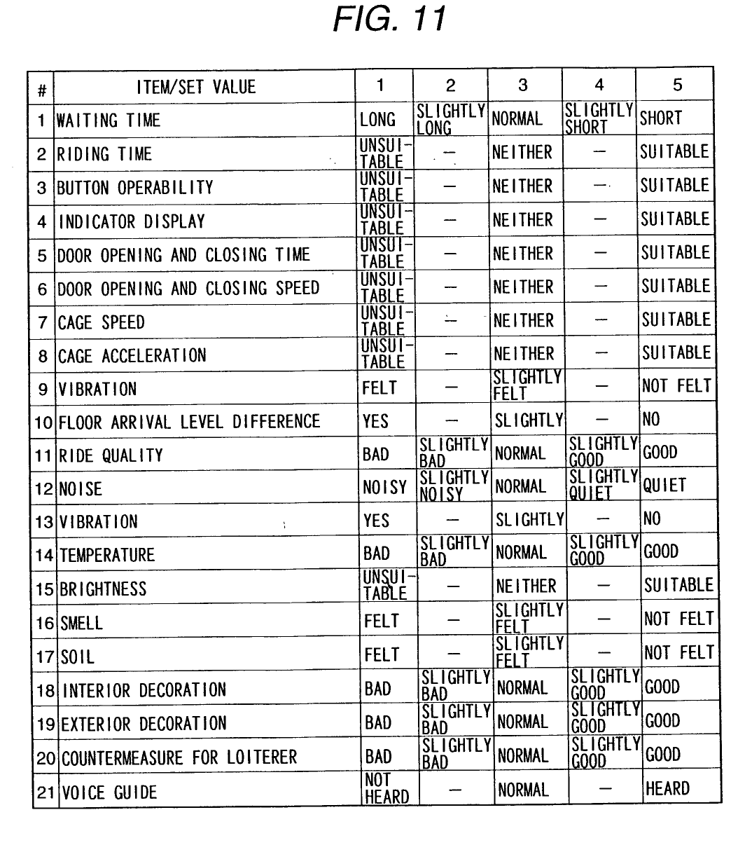

Further, FIG. 11 shows an example of a user questionnaire. It is used for an elevator user to evaluate services on 21 items including the waiting time and riding time. The evaluation set values are within the range from 1 to 5 and recorded as contents of the user questionnaire file 502.

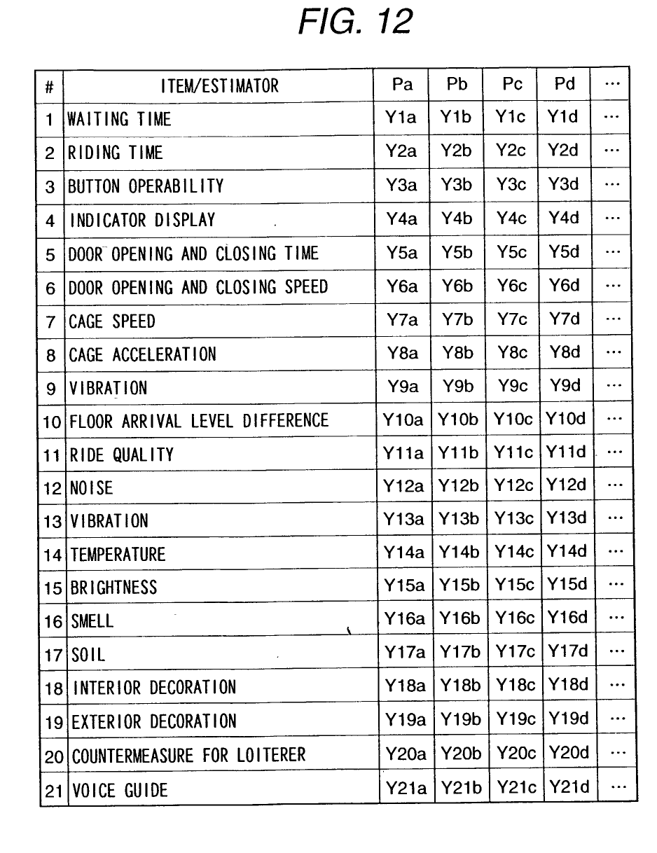

FIG. 12 shows a totaled example of all questionnaire results mentioned above, and Pa and Pb indicate individual evaluators answering the questionnaire, and for example, Y1a indicates an evaluation set value of the waiting time evaluated by the evaluator Pa, and Y2b indicates an evaluation set value of the riding time evaluated by the evaluator Pb, and all the evaluation set values are values within the range from 1 to 5.

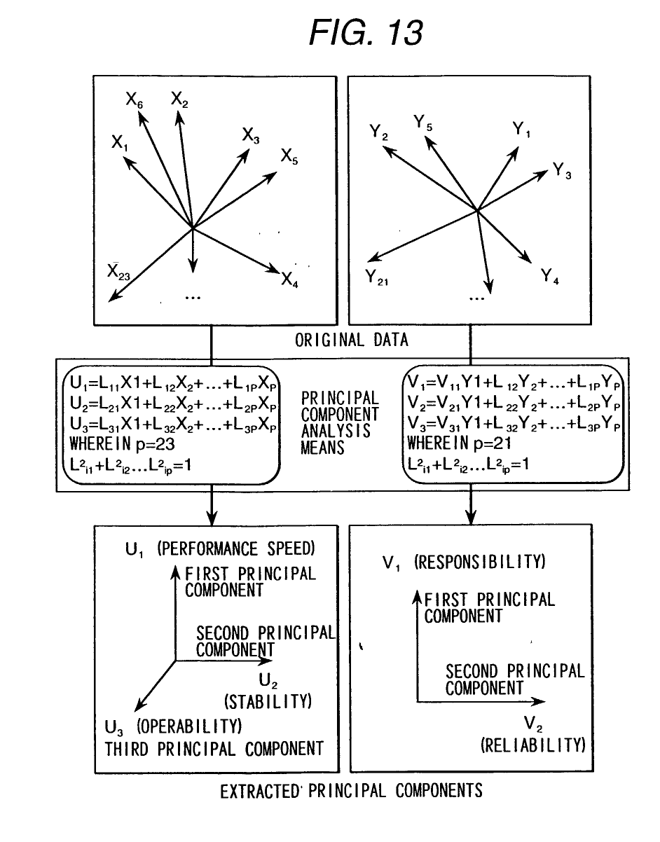

FIG. 13 is a brief illustration for the known main component analytical method. For example, the facility operation data shown in FIG. 10 has 23 evaluation items, so that the original data has 23 dimensions. When the main component analysis is applied to the data, for example, three main components such as the first main component U1, the second main component U2, and the third main component U3 can be extracted. This example means that a variable of originally 23 dimensions can be represented by three dimensions. Among the 23-dimensional spatial axes of the original variable, similar axes are integrated to three dimensions, so that the characteristics possessed by the original variable data are preserved. And, judging from the correlation coefficient between each main component and the original variable, the facility manager, for example, gives a name of high speed to U1, a name of stability to U2, and a name of operability to U3. This embodiment uses the main components extracted in this way as a user interface for service selection.

FIG. 14 shows an example of a main component operation screen at a terminal. In this example, the maintenance service characteristics for an elevator are represented by two parameters of V1 and V2 as a result of user evaluation and by three parameters of U1, U2, and U3 as a result of facility operation evaluation. The results of evaluation of services by the 5 parameters in total are the contents of the window 602 and the evaluation results of services of three companies such as D1, Ltd., D2, Ltd., and D3, Ltd. are shown in the drawing. On the other hand, the values input to the system by the facility owner according to the facility operation intention are the contents of the user evaluation input window 604 and the facility operation evaluation window 605.

In the example shown in the drawing, parameter values are input using a slider. For example, when the facility owner gives priority to fast response and high speed, large values may be set by the slider. When values are set by the slider, they are compared with the evaluation result of the service characteristics of the window 602 and the value having a minimum difference is displayed as a recommended maintenance plan. According to this embodiment, the main component analytical results are used, so that the service characteristics can be displayed by a small number of parameters, and the intention of the facility owner can be input by the slider operation, thus there is an effect that an easily operable user interface can be provided.

In the aforementioned embodiment, the screen for operation intention input and service selection is used for the operation at the owner terminal 2. However, this information can be displayed on the user terminal 3. For example, in a case of a lease apartment, the operation intention of the apartment owner is displayed on the terminal in the residence of a resident of the apartment. According to this embodiment, there is an effect that the operation intention of the facility owner can be made widely known to the facility users.

Unlike the aforementioned embodiment, the screen for operation intention input and service selection can be displayed on the facility 50. For example, some elevator may have a liquid crystal display in its cage, and the operation intention can be displayed also on it, so that in the same way as with the aforementioned, there is an effect that the operation intention of the facility owner can be made widely known to the facility users.

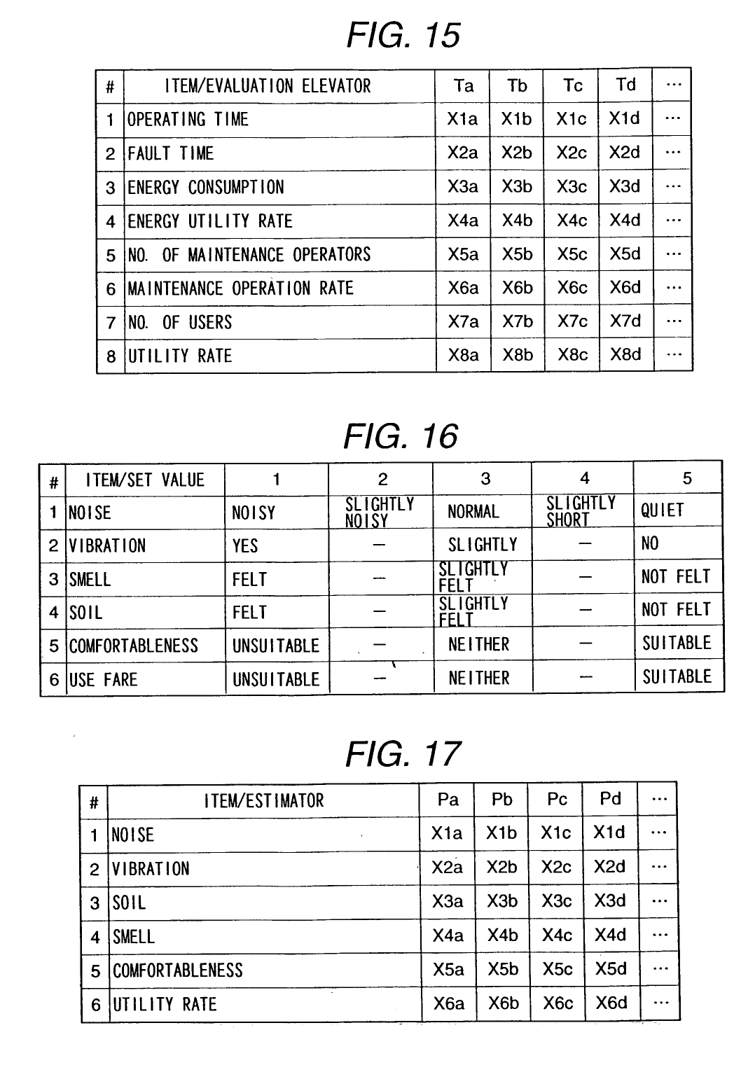

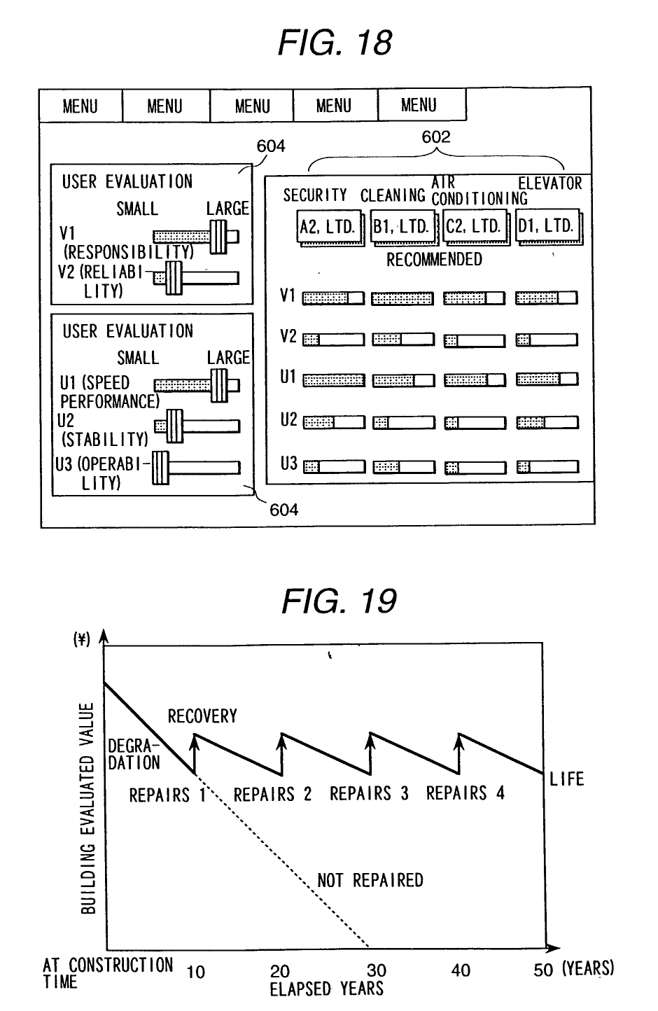

Further, the main component analysis can be applied also to evaluation of a plurality of kinds of maintenance services. For example, to evaluate different services such as guide, cleaning, air conditioning, and an elevator, the items of facility operation data and user questionnaire may be set to contents which can be commonly evaluated. For example, the facility operation data shown in FIG. 15 is set to contents common to each maintenance service such as the operating time and fault time. Also in the user questionnaire shown in FIG. 16, the common contents such as noise and vibration are evaluation items. In the same way, FIG. 17 is user evaluation data, which is totaled results of FIG. 16. A screen example in this case is as shown in FIG. 18. In the same way as with FIG. 14, when the evaluation value is designated by the user using the slider, a maintenance company having a minimum difference from it is calculated. In this example, the recommended companies are displayed respectively for guide, cleaning, air conditioning, and elevator.

In the aforementioned embodiment, when the facility operation intention is input, the maintenance company suitable for it is displayed, though as shown in FIG. 23, the maintenance service level can be displayed. The service level in this case is contract conditions requiring satisfaction of the maintenance company. For example, in the example shown in FIG. 14, the services of D1, Ltd. are closest to the designated values of the service characteristics of the facility operation evaluation 605. Then, when the facility operation data shown in FIG. 10 are checked for the elevator maintained by D1, Ltd., in the example shown in the drawing, values of the 23 parameters can be obtained. Then, the maintenance company guarantees it as a service level that the lower limit value and upper limit value are set for each of the obtained parameter values and each of predetermined parameter values is within a fixed range. Here, from the data shown in FIG. 10, door opening-closing acceleration, floor arrival error, and speed variation are selected as parameters of the service level. With respect to the three parameters, the values in the present operation are indicated as present condition values and when each of them is between the lower limit value and the upper limit value, it is considered that the service level promised by the maintenance company is satisfied. This screen is displayed on the facility owner, maintenance company, facility user, or facility.

According to this embodiment, the maintenance service level is indicated, and anyone can confirm that the present condition is within the promised range, so that there is an effect that understanding for sharing the maintenance cost can be easily obtained.

Hereunder, the sub-system of step group management will be explained. FIG. 19 is an illustration for a building repair model. The graph shown in the drawing indicates the relation between the elapsed year from building construction and the estimated value of building. At the time of construction of a building, a fixed building estimated value is given. However, the structure and facilities are degraded, so that when they are not repaired, the estimated value is reduced as shown by a dotted line. A means for recovering the reduction in the estimated value is repairs and large-scale repairs such as repairs of the outer wall and waterproofing of the roof are called large-scale repairs. Even in the case of repairs, there is the life of a building, so that large-scale repairs are executed repeatedly in a cycle of 10 years or 20 years. From the viewpoint of management of the life cycle of a building, it is important to execute repairs suitably, thereby lengthen the life span of the building, and keep the estimated value of the building at a high level.

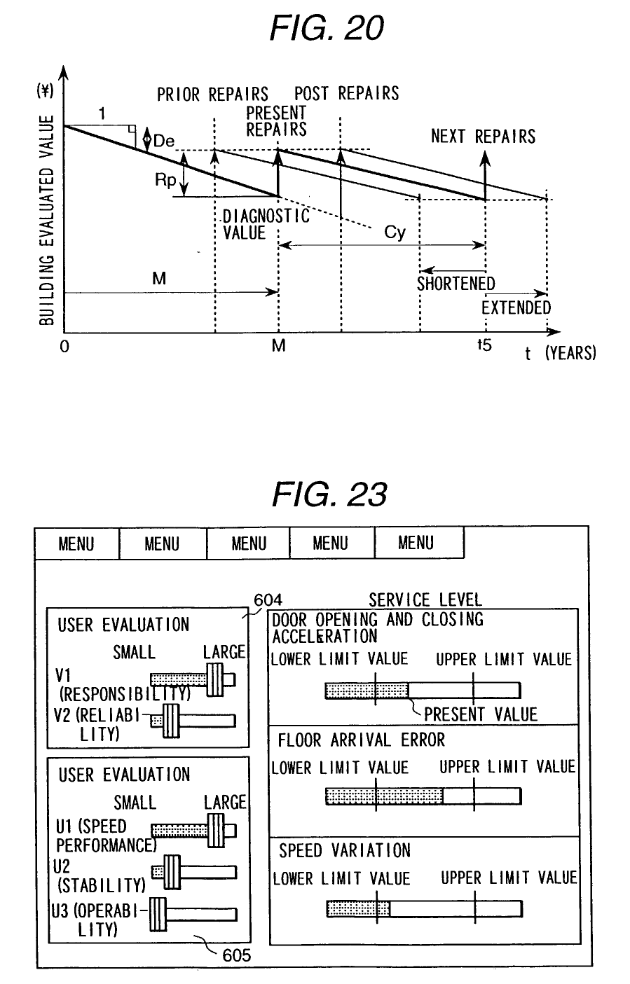

FIG. 20 shows a model for adjusting the repair time on the basis of a repair model. From the viewpoint of group management of buildings, by coinciding the repair times with each other, a large effect of decrease in cost can be produced. Therefore, the construction start time is adjusted by this model. As a result of diagnosis of a building, it is assumed that an estimate that the estimated value of the building lowers by De (a positive number) every year, and repairs are required after M years, and the repair cost is Rp, and the life of repair is Cy years is obtained. However, in this case, the repair cost is perfectly reflected on recovery of the estimated value.

Firstly, with respect to the present repairs, in a case of prior repairs, the degradation of the building does not proceed, so that the repair cost is lower than Rp. On the other hand, in a case of post repairs, the repair cost is higher than Rp due to proceeding of degradation. In consideration of only the present repairs, it is desirable to make prior repairs as far as possible. However, in consideration of the next repairs so as to investigate the life cycle cost, a different result is obtained. When the present repairs are made earlier, the life of the building is not changed, so that the period up to the next repairs is shortened and a disadvantage will result. Therefore, so as to minimize the cost of the present and next repairs, the construction start time is calculated. Then, assuming that the construction of a building is started after t years, the present repair cost C0 is:

C0=Rp−De*(M−t) Formula 1

and the cost C1 due to shortening or prolongation of the next repairs is evaluated by:

C1=Rp/Cy*(M−t) Formula 2

The total repair cost C of the two is:

C=C0+C1=Rp−(De−(Rp/Cy))*(M−t) Formula 3

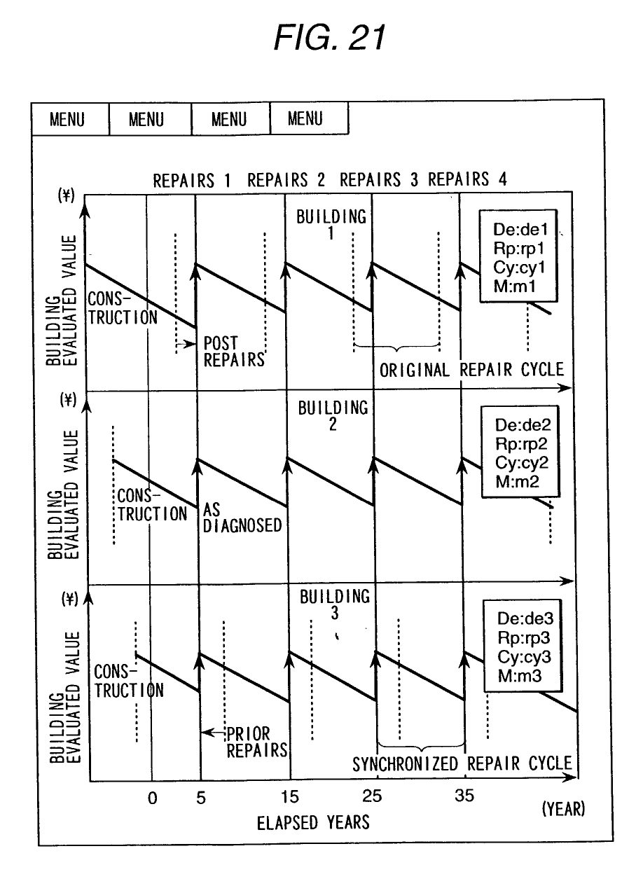

FIG. 21 shows a screen example of the step group management sub-system, in which the times of large-scale repairs of three buildings are synchronized. In this example, each building is under the same specification, though the construction start time is different from each other. Therefore, the original repair cycle is the time indicated by a dotted line. However, for synchronization, the drawing shows that the construction is started as post repairs for the building 1, as diagnosed for the building 2, and as prior repairs for the building 3. The input parameters for synchronization are De, Rp, Cy, and M for the respective buildings and there is a window provided for inputting and displaying these values obtained by diagnosis. In this case, to decide a most suitable construction start time, it is desirable to decide the value of construction start time t so as to minimize the value obtained by adding the repair C of each building. Synchronization in this case means just decision of the construction start year of the repair work but does not mean start of the repair work of each building exactly on the same day. The resources such as operators of the construction are limited, so that although details are decided according to the step plan, the construction is sequentially started by shifting some days.

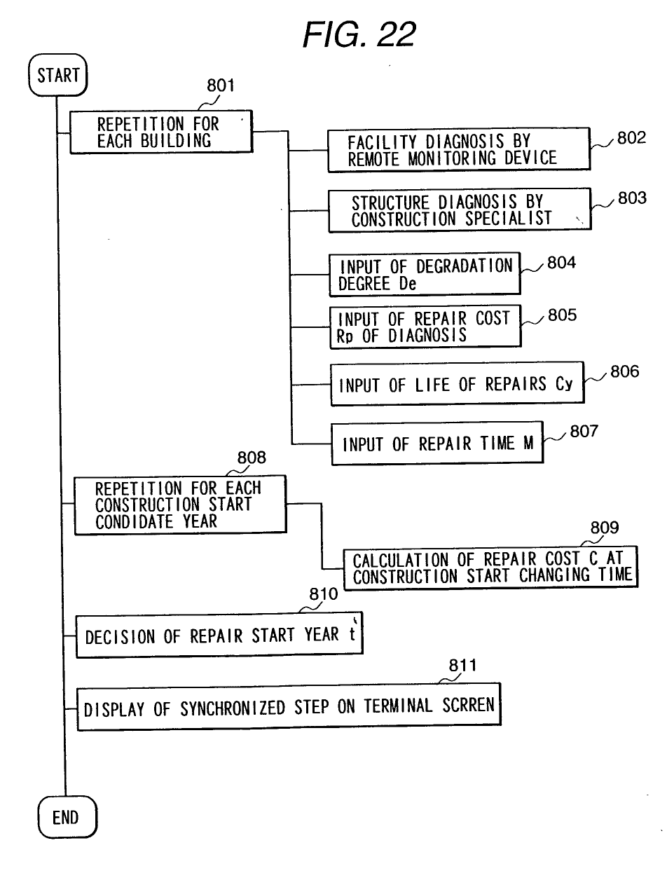

Next, the process of the step group management sub-system will be explained by referring to the flow chart shown in FIG. 22. Step 801 means repetition of the process for each building. Step 802 means the diagnostic process for facilities by the remote diagnostic device, which judges degradation conditions of facilities such as an air conditioner and an elevator from vibration and variations in the control values. Step 803 means the structure diagnostic process by a construction specialist, which judges degradation conditions of outer walls and reinforcing bars. From the two diagnostic results mentioned above, the values of degradation degree De (Step 804), repair cost Rp (Step 805) due to diagnosis, life of the building Cy (Step 806), and repair time M (Step 807) are input. Step 808 means repetition of the process for each construction start candidate year. Step 809 calculates the repair cost C when the construction start is changed. All available cases are calculated and Step 810 decides the repair start year t so as to minimize C. And, Step 811 displays the synchronized step on the terminal screen.

According to the operation group management sub-system of the present invention, a combination of most suitable maintenance companies according to the object is indicated, so that there is an effect produced that the facility owner may only select a combination of maintenance companies according to his management intention and easily can select suitable companies. Further, evaluation of maintenance services is executed continuously, so that the facility operation is suitably executed according to the management intention.

Further, the results of evaluation of maintenance companies are stored in the server and can be read by any of the facility manager, facility owner, facility users, and maintenance companies, so that there is an effect produced such that the transparency of ranking of maintenance services can be improved. Furthermore, the construction start times of large-scale repairs of buildings can be synchronized by the step group management sub-system, so that the scale merit can be utilized in respect of supply and distribution by the simultaneous work and the cost of work can be decreased.

What is claimed is

1. A building group management service support method for managing facilities composed of a plurality of maintenance subjects using a computer system by a facility manager entrusted with operations of a plurality of maintenance companies for executing maintenance for each of said maintenance subjects for said facilities from a facility owner having said facilities, and said computer system is connected to a facility owner terminal and a facility manager terminal via a network, and
said facility manager terminal extracts maintenance service characteristics of each of said maintenance companies, decides combinations of maintenance companies having same said service characteristics of all said maintenance subjects as maintenance plans, decides evaluation for operations of said facilities as facility operation evaluation on the basis of maintenance information including a fault time or fault contents output from said facilities, and indicates said plurality of maintenance plans and said facility operation evaluation on said facility owner terminal, and
said facility owner terminal selects a maintenance plan entrusted with management from said plurality of maintenance plans and notifies said facility manager terminal of said maintenance plan.

2. A building group management service support method according to claim 1, wherein said computer system includes a facility user terminal connected via said network and said facility manager terminal requests a user questionnaire for entering a degree of use satisfaction to a facility user using said facilities, decides an analytical result of said user questionnaire as user evaluation, and when said maintenance plan and said facility operation evaluation are to be indicated on said facility owner terminal, indicates said user evaluation.

3. A building group management service support device for buildings for managing facilities composed of a plurality of maintenance subjects using a computer system by a facility manager by trust with operations of a plurality of maintenance companies for executing maintenance for each of said maintenance subjects for said facilities from a facility owner having said facilities, wherein said computer system is connected to a facility owner terminal and a facility manager terminal via a network, and
said facility manager terminal has a maintenance service combination display unit for displaying, from a result of extraction of maintenance service characteristics of each of said maintenance companies, a result of decision as a combination of maintenance companies having same said service characteristics of all said maintenance subjects and a facility operation evaluation display unit for displaying evaluation decided for said facility operation on the basis of maintenance information including a fault time or fault contents output from said facilities, and
said facility owner terminal has a maintenance plan selection unit for selecting a maintenance plan prepared as a combination of maintenance companies by said facility manager.

4. A building group management service support device according to claim 3, wherein said facility owner terminal has a user evaluation display unit for requesting a user questionnaire for entering a degree of use satisfaction to a facility user using said facilities, deciding an analytical result of said user questionnaire as user evaluation, and displaying said user evaluation.

5. A building group management service support system, wherein input/output data in said maintenance service combination display unit, or said facility operation evaluation display unit, or said user evaluation display unit, or said maintenance plan selection unit which are described in claim 3 or 4 is registered in a server connected to said network and
said facility manager terminal, or said facility owner terminal, or said maintenance company terminal, or said facility user terminal refers to said input/output data via said network.

6. A computer program storage medium which is a program storage medium for storing a computer program capable of being read by a computer stores a program code of said device or said system described in claim 3, or 4, or 5.

7. aid facility operation evaluation or said user evaluation is executed by a terminal of an evaluation company which is a third person independently of said facility manager or said maintenance companies.

8. A building group management service support system having a computer, wherein said computer has conversion means for converting first condition data of a predetermined number of parameters for indicating an input operation condition of building facilities and service characteristics to second condition data that said number of parameters is reduced by holding said characteristics of said operation condition represented by said data and calculation means for outputting, when an indicated value is input by a parameter of said second condition data, information for identifying a facility having said second condition data closest to said indicated value.

9. A building group management service support system, comprising:
a computer,
means for generating first condition data of a predetermined number of parameters for indicating an evaluation condition of facilities of a building on the basis of data of questionnaire results for users of said building facilities,
means for converting said first condition data to second condition data that said number of parameters is reduced by holding characteristics of said evaluation condition represented by said first condition data, and
means for calculating and outputting information for identifying a facility having said second condition data when an indicated value is input by a parameter of said second condition data.

10. A building group management service support system according to claim 8 or 9, wherein as a range for promising management of said first condition data, an upper limit value and a lower limit value are preset and a present value, said lower limit value, and said upper limit value of said first condition data are output.

11. A building group management service support method for planning repair work of a plurality of buildings for which a repair time and a repair cost of next repairs of said buildings, a life of repairs indicating a time up to successive repairs, and a building estimated value indicating an economical value of said buildings are estimated using a computer, wherein:
said computer calculates a variation of said repair cost when said repair time is to be changed within a predetermined time on the basis of said life of repairs and said building estimated value and changes said repair time so as to minimize a total of said repair cost of said plurality of buildings and said variation.

12. A building group management service support method according to claim 11, wherein in said next repairs, a same construction method and same materials are set to be used for repairs of said plurality of buildings and a repair time after said successive repairs is planned to generate in a same cycle.

13. A building group management service support system according to claim 11, wherein said system is a computer system and when said repair time, said repair cost, said life of repairs, and said building evaluated value of said plurality of buildings are input by an input device, said repair time for each building is synchronized and a value changed to a most suitable repair time is output from an output device.
